(19) United States
(12) Patent Application Publication
(10) Pub. No.: US 2008/0064237 A1
(43) Pub. Date: Mar. 13, 2008

(54) Wireless adapter apparatus for portable information appliances

(76) Inventor: Eric Tan, Bellevue, WA (US)

Correspondence Address: Anthony Claiborne, 849 136th Ave. N.E., Bellevue, WA, 98005, US

(21) Appl. No.: 11/893,998

(22) Filed: Aug. 16, 2007

Related U.S. Application Data
(60) Provisional application No. 60/838,495, filed on Aug. 16, 2006.

(51) Int. Cl. H01R 13/648

(52) U.S. Cl. 439/101

(57) ABSTRACT

Improvements in technology related to adapters that enable portable information appliances to practice wireless network communications, in particular Internet communications, include use of such adapted appliances for: web browsing; receipt, recording and transmission of audio and video media; email, instant messaging, SMS and other electronic communications activities; and electronic gaming, including gaming with software received via network and multi-player online gaming. Improvements further employ stored memory in the adapter to enable an adapted appliance to serve as a personal information manager. Improvements further include use of stored memory for the adapted appliance to enable the user to obtain paid services such as voice telecommunications. Stored memory further permits the adapted appliance to function as an electronic wallet for the purchase of goods and services. Configurable user interface and ornamentation of the adapter permit advantageous branding of the user experience and/or adapted appliance.

### CROSS-REFERENCE TO RELATED APPLICATION

This application claims priority from U.S. application No. 60/838,495 filed Aug. 16, 2006, entitled IMPROVEMENTS RELATED TO WIRELESS ADAPTER APPARATUS FOR PORTABLE INFORMATION APPLIANCES.

### BACKGROUND OF THE INVENTION

1. Field of the Invention

This invention relates to wireless network communications devices. More particularly, this invention relates to improvements in technology related to adapters that enable portable information appliances to practice wireless network communications, in particular Internet communications.

2. Description of the Related Art

Previous applications for patent by the inventor of the present invention, cited above for priority and incorporated herein by reference, have been directed to adapters for information appliances, such as cellular telephones (U.S. patent application Ser. No. 11/348,728) and portable media players (provisional U.S. patent application 60/777,103), whereby the adapter provides such an information appliance with wireless network connectivity. Those prior applications have been principally directed to embodiments wherein the wireless connectivity provided by the adapter enables the appliance to serve as a wireless telephone by practicing voice over internet protocol (VOIP) telephony employing the wireless network connection provided by the adapter.

However, the wireless network connectivity afforded by the adapter of the present invention permits other advantageous utilities which are the subject of the present specification.

### BRIEF DESCRIPTION OF THE INVENTION

The present invention provides improvements in technology related to adapters that enable portable information appliances to practice wireless network communications, in particular Internet communications, including use of such adapted appliances for: web browsing; receipt, recording and transmission of audio and video media; email, instant messaging, SMS and other electronic communications activities; and electronic gaming, further including gaming with software received via network and multi-player online gaming. Improvements further employ stored memory in the adapter to enable an adapted appliance to serve as a personal information manager. Improvements further include use of stored memory for the adapted appliance to enable the user to obtain paid services such as voice telecommunications. Stored memory further permits the adapted appliance to function as an electronic wallet for the purchase of goods and services. Configurable user interface and ornamentation of the adapter permit advantageous branding of the user experience and/or adapted appliance.

### BRIEF DESCRIPTION OF THE DRAWINGS

The foregoing and other aspects of the invention are further specified by the following description and by the accompanying drawings, wherein:

FIG. 1 is a diagrammatic depiction of use of the adapter in conjunction with a portable information appliance for web browsing via a wireless Internet connection;

FIG. 2 is a diagrammatic depiction of use of the adapter in conjunction with a portable information appliance for email communications via a wireless Internet connection;

FIG. 3 is a diagrammatic depiction of use of the adapter in conjunction with a portable information appliance for instant messaging communications via a wireless Internet connection;

FIG. 4 is a diagrammatic depiction of use of the adapter in conjunction with a portable information appliance for sending, receiving and playing audio and/or video media from a media server connected via a wireless Internet connection;

FIG. 5a is a diagrammatic depiction of use of the adapter in conjunction with a portable information appliance for downloading gaming applications via a wireless Internet connection and playing such game in the native software environment of the appliance;

FIG. 5b is a diagrammatic depiction of use of the adapter in conjunction with a portable information appliance for downloading gaming applications via a wireless Internet connection and playing such game in the native software environment of the adapter, with input and/or output functionality provided by the appliance; and

FIG. 6 is a diagrammatic depiction of the adapter in conjunction with a portable information appliance providing data repository functionality with a resident personal information manager or, alternatively, a personal information database residing on a server connected via a wireless Internet connection.

### DETAILED DESCRIPTION OF THE PREFERRED EMBODIMENTS

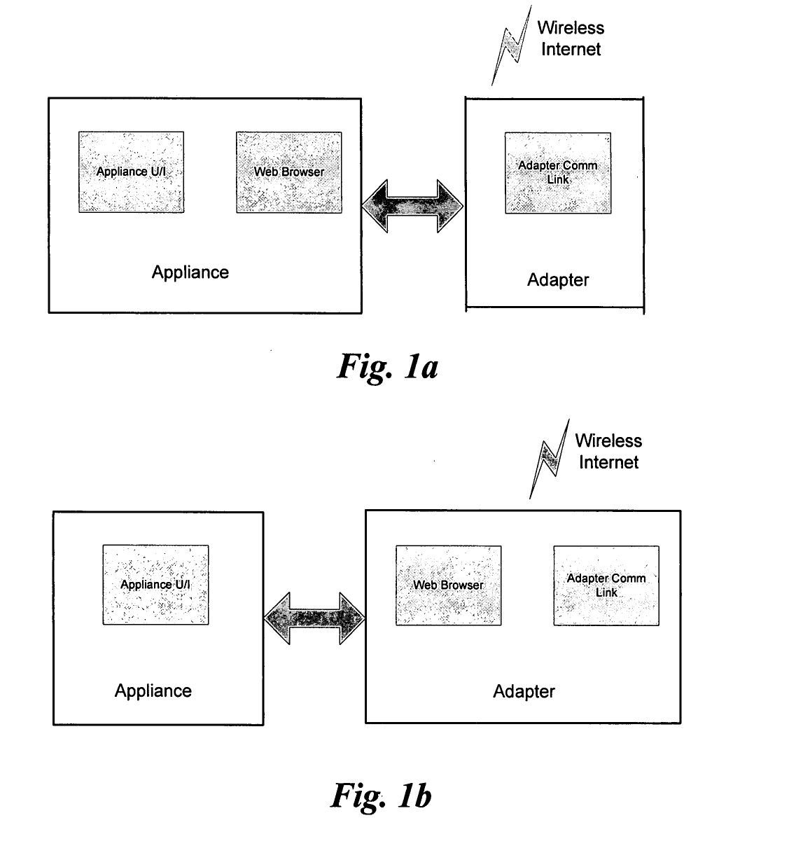

As mentioned in the '728 application, because many information appliances such as cellular telephones have built-in web browser software, the wireless network connectivity provided by the adapter of the present invention, enables web browsing over such connectivity using the appliance's native web browser to render web pages for viewing without need for a more expensive network connection, such as over a cellular telephone network (FIG. 1a). In other embodiments contemplated herein, the adapter itself may provide a connected portable information appliance not only with wireless Internet connectivity, but also with browser software configured to render web pages for the user on the information appliance. In such embodiments, therefore, the present invention thereby enables the user to employ the connected information appliance for web browsing (FIG. 1b).

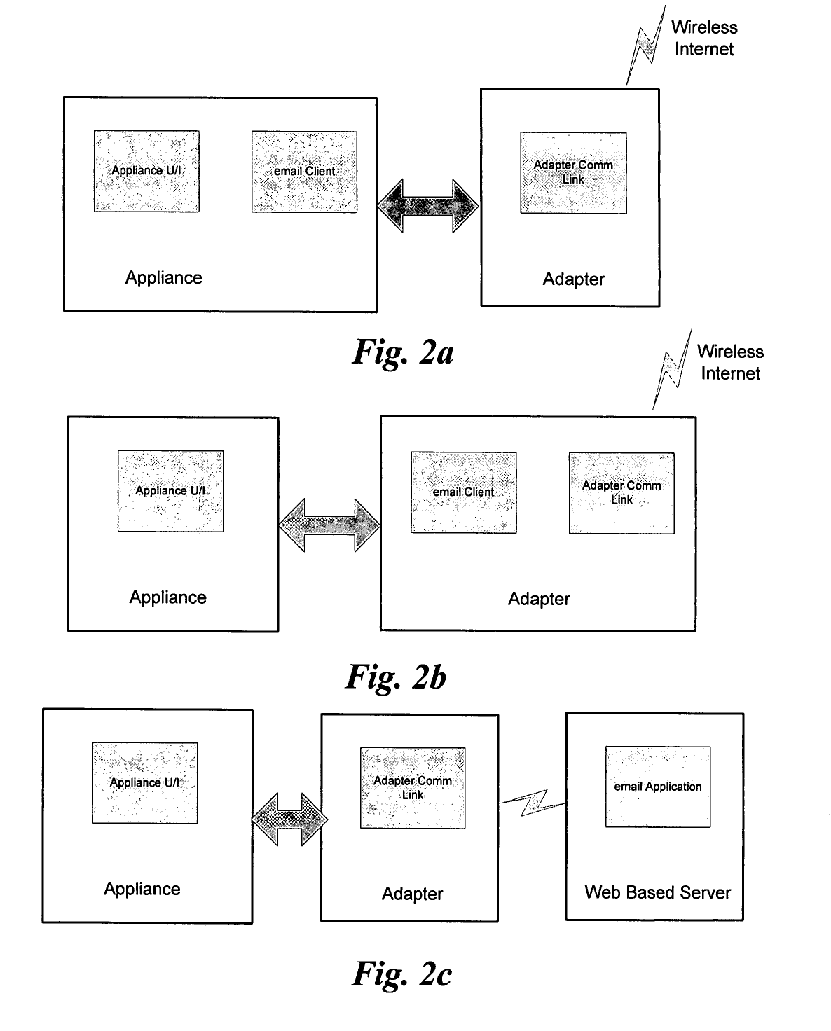

Similarly, other network utilities may advantageously be delivered to the user's adapter-equipped information appliance. For example, the adapter may mediate email communications employing the information appliance by any number of technological means, as will be well understood by those in the art. For example, the adapter may serve to receive and deliver email messages wirelessly from and to the network, the messages handled via an email client resident on the appliance (FIG. 2a). Alternatively, the adapter itself may provide the appliance with the email client software necessary for such communications (FIG. 2b). As yet another alternative, the user may employ the adapter to provide Internet access for use of browser technology either resident in the appliance or provided by the adapter, accessing email software on a remote Internet connected server (FIG. 2c).

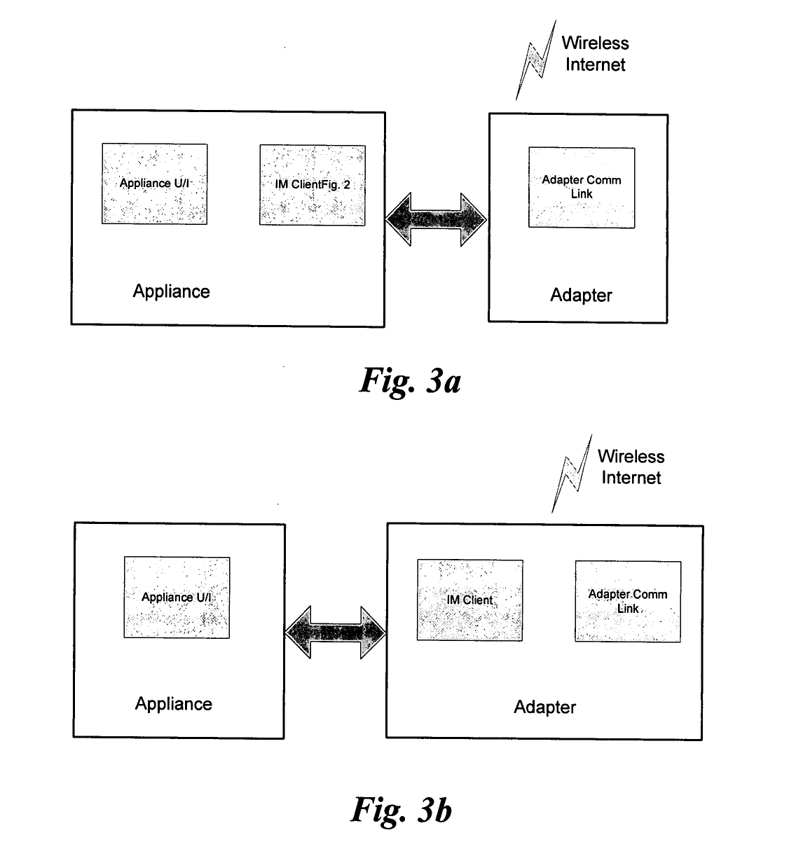

As will be appreciated by those of skill in the art, communications functionalities other than email may be implemented in embodiments of the present invention. For example, the adapter may facilitate wireless communications for an instant messaging client, the client either resident in the appliance (FIG. 3a) or provided to the appliance by the adapter (FIG. 3b), whereby the user may communicate with others via AIM, MSN Instant Messaging, or other messaging service. Similarly, communications via Short Message Service (SMS) may be mediated by the adapter and an SMS client, again either in the appliance itself or provided by the adapter (analogous to IM functionality depicted in FIGS. 3a and 3b). Those of skill in the art will appreciate that embodiments of the present invention may practice the entire range of one-to-one, one-to-many, many-to-many and many-to-one communications technologies that are available for network connected devices generally.

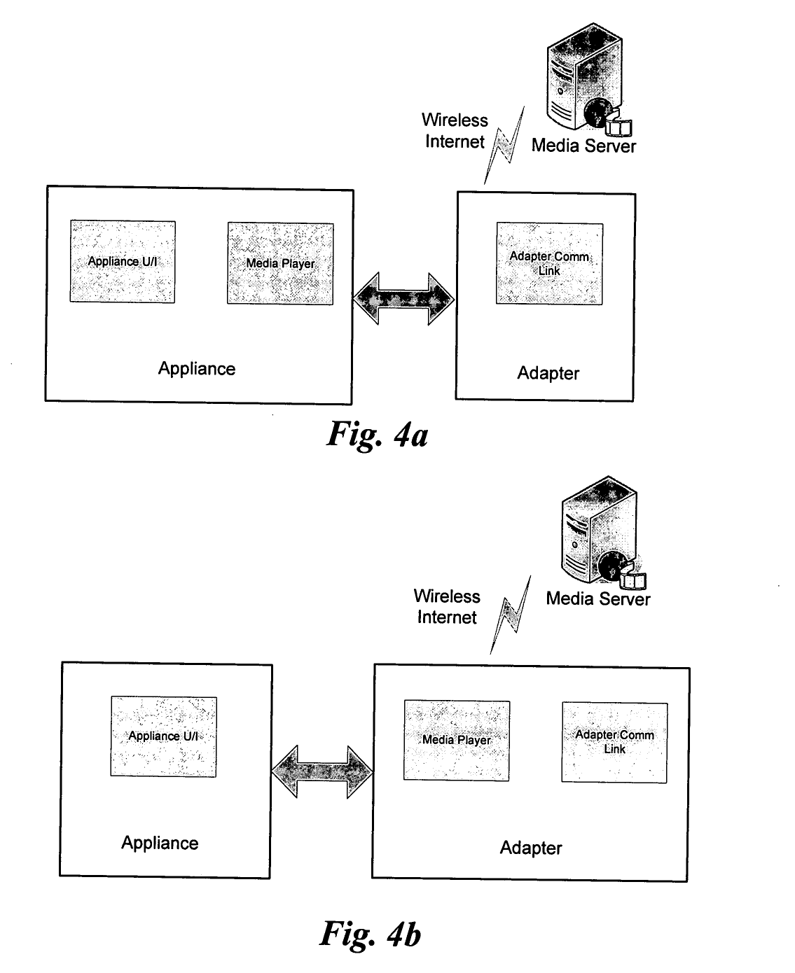

Yet further, embodiments permit the user to send and receive audio and video data via the wireless connectivity provided by the adapter. Player and/or media management functionality for the appliance may be provided by software resident on the appliance, as may be the case, for example, in some embodiments wherein the appliance itself is a portable media player, such as those described in provisional application for patent '103. FIG. 4a illustrates such an embodiment configured to receive and play media files received from the network via the adapter. In alternative embodiments, the adapter may provide software giving media player or recorder functionality to the information appliance, whereby the appliance may utilize such adapter functionality to record media files for transmission over the adapter's wireless interface, and/or the appliance may employ adapter functionality to play media files that are received from a media server over the network via the adapter (FIG. 4b). As will be appreciated by those of skill in the art, recording, transmission and playing or rendering of both static files and streaming media are within the scope of the present invention.

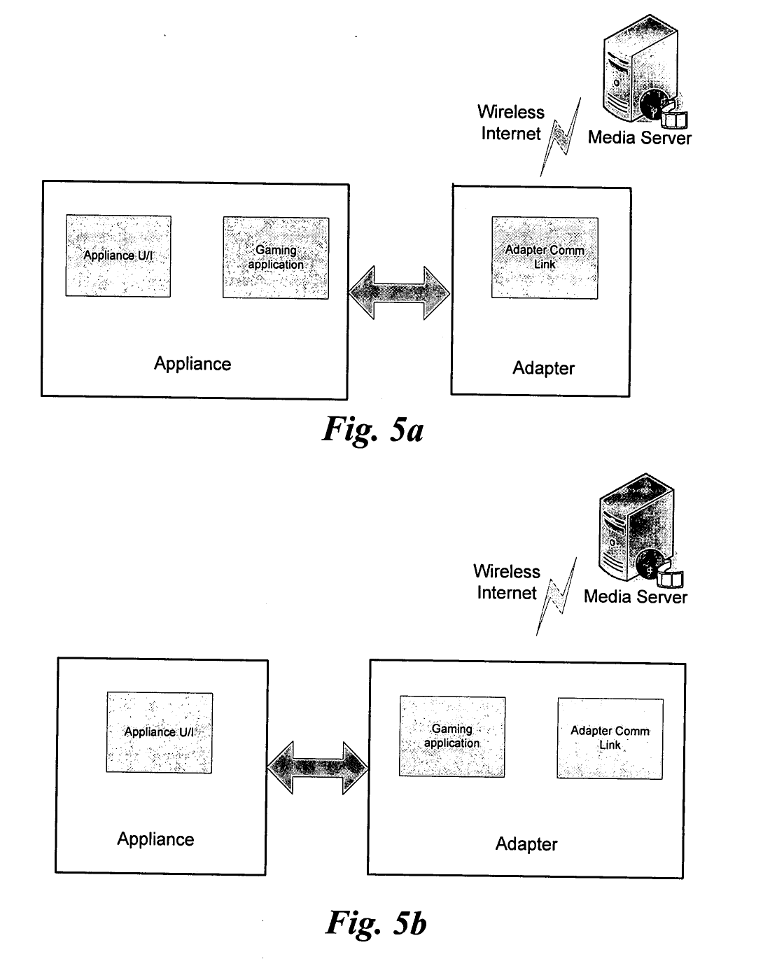

Similarly, a wide range of gaming functionality is within the scope of the present invention. The connectivity afforded by embodiments of the present invention permits the downloading of game software for the user to play on the information appliance. As will be appreciated by those in the art, such gaming software may comprise a software application downloaded to run in the native software environment of the appliance (FIG. 5a). Alternatively, the gaming software may be scripted, markup or other abbreviated instructions to software running in the appliance, such as a gaming client or even a browser. In other embodiments, the gaming software may execute within the adapter, relying on the information appliance for input and/or output functionality, such as pushbuttons and/or video screen (FIG. 5b). In yet other embodiments (not illustrated), gaming software on the adapted appliance may utilize the connectivity afforded by the adapter to permit the user to engage in multiplayer gaming over the Internet. Those of skill in the art will appreciate that all such gaming configurations and their variations are within the scope of embodiments of the present invention.

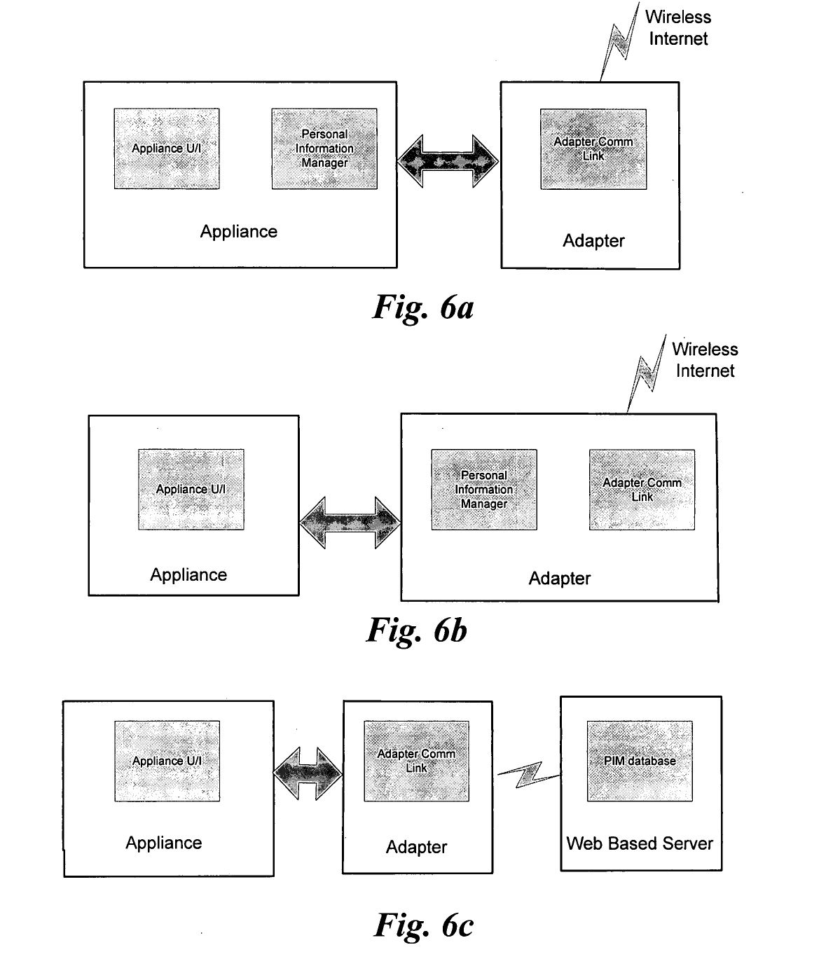

Further, besides providing wireless connectivity for the appliance, embodiments of the present invention with suitably adapted memory may provide data repository functionality for the appliance (FIGS. 6a and 6b). For example, embodiments of the present invention permit the storage by the user of valuable information, such as an address book, banking information, passwords, biometric identification parameters and the like. Because the adapter provides a wireless network connection, embodiments of the invention may further provide the ability to download, upload and or synchronize such information with a remote, server based data repository (FIG. 6c). As will be appreciated by those of skill in the art, embodiments of the present invention permit the connected appliance to provide functionality associated with a personal information manager (PIM), and the scope of such embodiments is as wide as the range of utilities afforded by PIM devices generally.

Embodiments of the adapter may be equipped with a memory module, such as flash memory, permitting personalized operation of the adapter (for example, operation based upon a stored originating telephone number for VOIP service) or for storage of personal information as set forth above. Embodiments may utilize a removable such module, providing a slot or similar receptacle in the adapter for insertion and removal of such a module, thereby permitting transfer of data from the adapter-equipped appliance to another device, which may be another adapter-equipped appliance.

Such a memory module may facilitate business models built around the various forms of connectivity provided by embodiments of the invention, such as the provision of VOIP service as described in prior application Ser. No. 11/348,728, as well as other forms of communication adaptable for provision as an access-based and/or usage-based paid service, in manner analogous to that whereby the cellular telephone Subscriber Identity Module (SIM card) facilitates certain cellular telephone service business models, including, in particular, the highly successful model of prepaid telephone service.

Embodiments may employ such a memory module in business models directed to data-based purchases of goods and services, such as those based upon a pre-paid or charge account, whereby card data is used to carry out the transaction, in a manner analogous to transactions carried out by credit or charge card (“electronic wallet”). The advantages of hardware, such as a SIM, to facilitate such business models, will be familiar to those of skill in the art and it is intended that all such embodiments are within the scope of the present invention.

Some embodiments of the adapted appliance provide a user interface under control of the adapter. Interfaces may be configured so that functionalities provided by embodiments of the adapter, some of which are set forth above, leverage the brand recognition, familiar look-and-feel, continuity of user experience, and the like that are afforded by a programmed user interface. Furthermore, the adapter itself, as a physical object affixed to the information appliance, may present branding ornamentation to the user. It is intended that all such branding applications be within the scope of embodiments wherein the adapter provides a user-facing aspect.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention.

I claim:

1. An adapter configured to connect to and communicate with a portable information appliance, the adapter comprising
a means for coding and packetizing signal data from the information appliance along with control data according to a wireless telecommunications protocol;
a means for decoding packetized data received in wireless telecommunications protocol format; and
a means for two-way wireless communication of packetized data with a wireless network router.

2. An adapter according to claim 1, further comprising a memory module in communication with the adapter.

3. An adapter with memory module according to claim 2, wherein the memory module is adapted for storing user data of interest.

4. An adapter with memory module according to claim 3, wherein the memory module and adapter are adapted to communicate user data of interest stored in the memory module with a connected portable information appliance.

5. An adapter with memory module according to claim 2, wherein the memory module is adapted for storing data required for Internet communications, the memory module further adapted to provide said data to at least one of the adapter and a connected portable information appliance.

6. An adapter with memory module according to claim 2, wherein the memory module is adapted for storing data required for paid services obtainable via the Internet, the memory module further adapted to provide said data to at least one of the adapter and a connected portable information appliance.

7. An adapter with memory module according to claim 2, wherein the memory module is adapted to store data required for wireless purchasing transactions, the memory module and adapter configured to communicate said data in a wireless purchasing transaction when a portable information appliance is connected to the adapter.

8. An adapter with memory module according to claim 2, wherein the memory module is removable.
